(19) United States
(12) Patent Application Publication
(10) Pub. No.: US 2017/0323348 A1
(43) Pub. Date: Nov. 9, 2017

(54) METHOD, APPARATUS, AND COMPUTER-READABLE MEDIUM FOR CONTENT DELIVERY

(71) Applicant: FUNCTIONAL M, INC., Santa Monica, CA (US)

(72) Inventors: DANIEL KENYON, NOVATO, CA (US); BRUCE DRESSER, WALNUT CREEK, CA (US); MARIO KENYON, MARINA DEL REY, CA (US)

(21) Appl. No.: 15/493,984

(22) Filed: Apr. 21, 2017

Related U.S. Application Data
(60) Provisional application No. 62/325,934, filed on Apr. 21, 2016.

(51) Int. Cl. G06Q 30/02; G06F 17/30; G06Q 50/00

(52) U.S. Cl. CPC G06Q 30/0271; G06Q 30/0201; G06Q 30/0243; G06F 17/30035; G06F 17/30997; G06Q 50/01

(57) ABSTRACT

Method, apparatus, and computer-readable medium for content delivery, including receiving a plurality of content items and target criteria corresponding to a target consumer of the plurality of content items, embedding a plurality of metadata tags in the plurality of content items based at least in part on the target criteria, storing the plurality of content items in a campaign data structure, transmitting a content item in the plurality of content items to a user, selecting a content path from the one or more content paths linked to the content item within the campaign data structure based at least in part on one or more metadata tags embedded in a next content item in each of the one or more content paths and a user profile corresponding to the user, and transmitting information associated with the next content item in the selected content path to the user.

### RELATED APPLICATION DATA

This applications claims priority to U.S. Provisional Application No. 62/325,934 filed on Apr. 21, 2016, the disclosure of which is hereby incorporated by reference in its entirety.

### BACKGROUND

Manual processes or programming are currently utilized to select content for mass consumption via theatrical distribution and broadcast television. Mobile, Over the Top (“OTT”) and TV Everywhere connected services are beginning to offer content to audience targeting services within their networks. TV Guide or other similar digital program guide services or directories offer television or digital media content targeting. Consumers can also search in a web browser for their content, but this too becomes time consuming.

Independent content producers do not have affordable tools to develop, own the data for, manage assets, easily distribute, campaign and target audiences; let alone generate revenue. However, independent producers are becoming current and future leaders of how content will be received and watched. There already is competition with the traditional media owners as platforms serving short-form content and virtual reality by “indies” or independents becomes the trend for consumers.

Independent producers along with producers at major studios tend to be disintermediated from their audiences. Independent producers are the leading content creators online; it takes a lot of time and resources (e.g., money) to bring together multiple disparate systems to capture and analyze viewer engagement to further entertainment media discovery. Guides and program services have proven to be cumbersome and ineffective at providing an easy method for viewing consumers to find and follow the content they want to watch or engage with. Several companies are looking to find solutions to get content to audiences based on viewer preferences in an automated fashion.

The system and methods of various embodiments of the present disclosure overcome the above and other disadvantages of the prior art.

### BRIEF SUMMARY

The present disclosure relates generally to systems and methods for content delivery, specifically, for automatically matching specifically labeled and curated, multi-format entertainment media content, and content elements with an identified user base and micro-target individual users with entertainment media offers to consume media throughout a content campaign. The user base can be aggregated through the identification and accumulation of user metrics generated from historic data, profiles and/or behavioral analysis. Individual user data can again be aggregated to establish scored rankings that quantify user interest. Predictive models can determine individual user interest in specific entertainment media categories and specific media titles. The system can be used to pair specifically labeled entertainment media content with specific user identities in order to present optimized invitations and offers to the users that request them to consume the specified content.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings various illustrative embodiments. It should be understood, however, that the invention is not limited to the precise arrangements and instrumentalities shown. In the drawings:

FIG. 1 illustrates a schematic diagram of the system for content delivery according to an exemplary embodiment.

FIG. 2 illustrates a magnified portion of the schematic diagram of FIG. 1.

FIG. 3 illustrates a dashboard or graphical user interface for tracking a content delivery campaign according to an exemplary embodiment.

FIG. 4 illustrates another dashboard or graphical user interface for tracking a content delivery campaign according to an exemplary embodiment.

FIG. 5 illustrates a circular diagram of different components and functions of the content delivery system according to an exemplary embodiment.

FIG. 6 illustrates a schematic diagram of a dynamic matching platform according to an exemplary embodiment.

FIG. 7 illustrates a schematic diagram of an end-to-end platform and engagement process according to an exemplary embodiment, wherein users are converted to virtual reality consumers.

FIG. 8 illustrates a schematic diagram of a matching algorithm for mobile engagement to build viewership according to an exemplary embodiment.

FIG. 9 illustrates a schematic diagram of a use case example for mobile engagement according to an exemplary embodiment.

FIG. 10 illustrates a schematic diagram of use of branded engagement to build a virtual reality consumer audience according to an embodiment of the present disclosure.

FIG. 11 illustrates a generalized, schematic diagram of a two sided platform according to an embodiment of the present disclosure.

FIG. 12 illustrates a schematic diagram of a production platform with integrated social promotion according to an embodiment of the present disclosure.

FIG. 13 illustrates criteria for matching virtual reality content to users according to an embodiment of the present disclosure.

FIG. 14 illustrates a flowchart for content delivery according to an exemplary embodiment.

FIGS. 15A-15D illustrate system charts and flowcharts for content and content path selection in the context of a virtual reality platform.

FIG. 16 illustrates an exemplary computing environment that can be used to carry out the method for performing functional testing of software.

### DETAILED DESCRIPTION

Certain terminology is used in the following description for convenience only and is not limiting. Certain words used herein designate directions in the drawings to which reference is made. Unless specifically set forth herein, the terms “a,” “an” and “the” are not limited to one element, but instead should be read as meaning “at least one.” The terminology includes the words noted above, derivatives thereof and words of similar import.

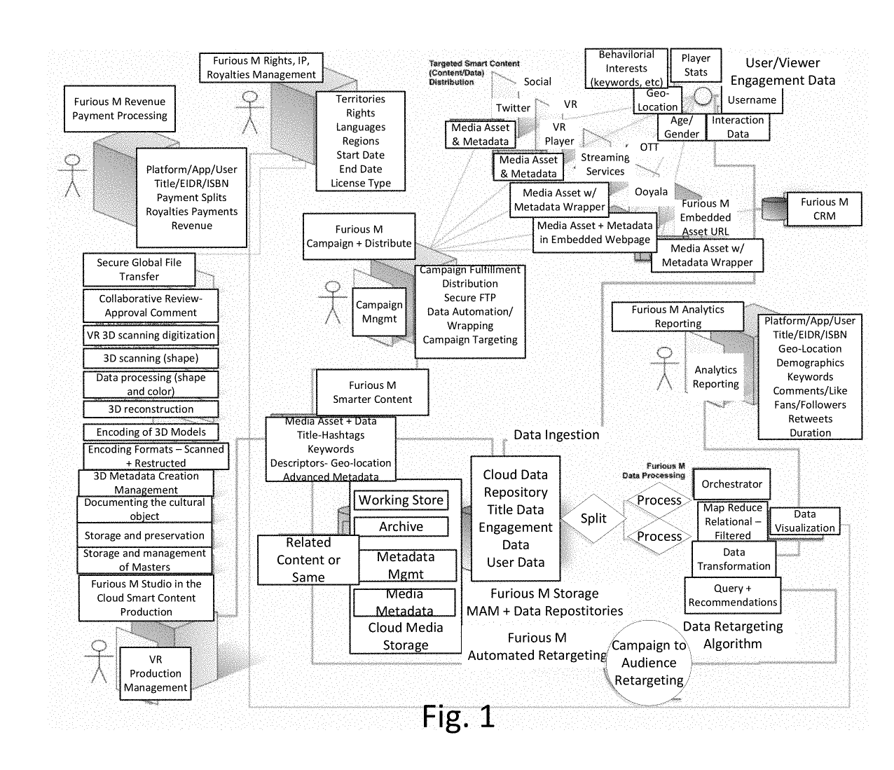

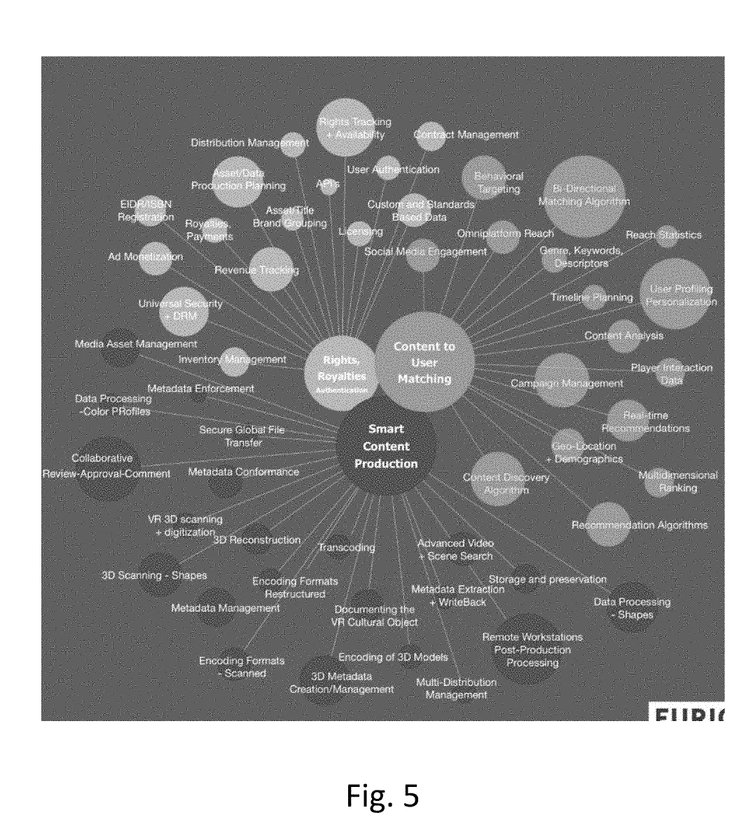

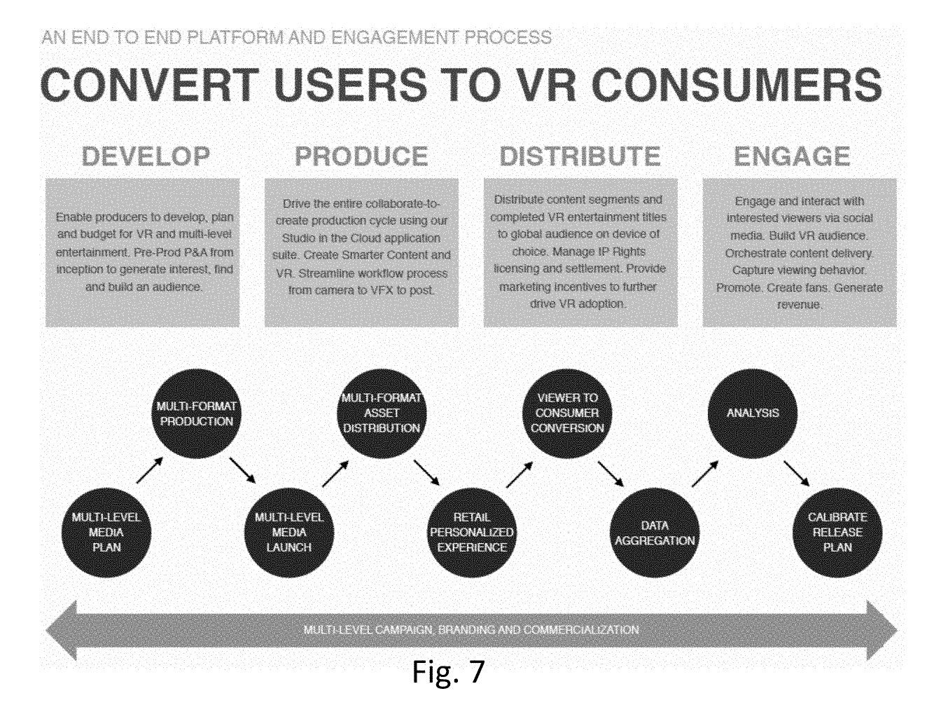

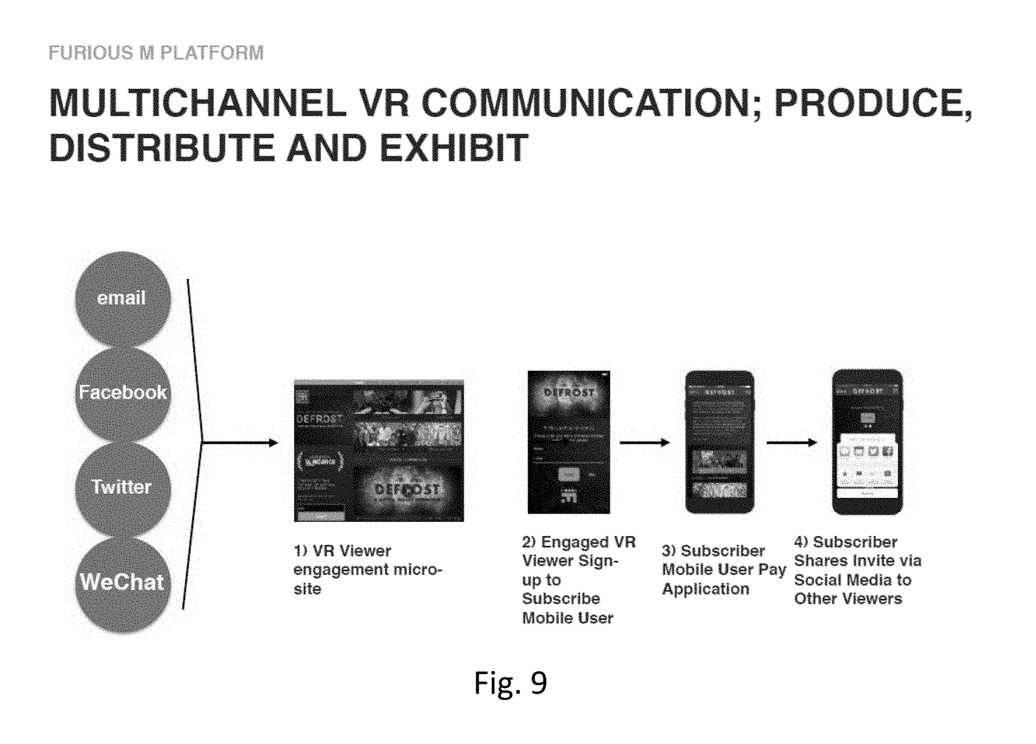

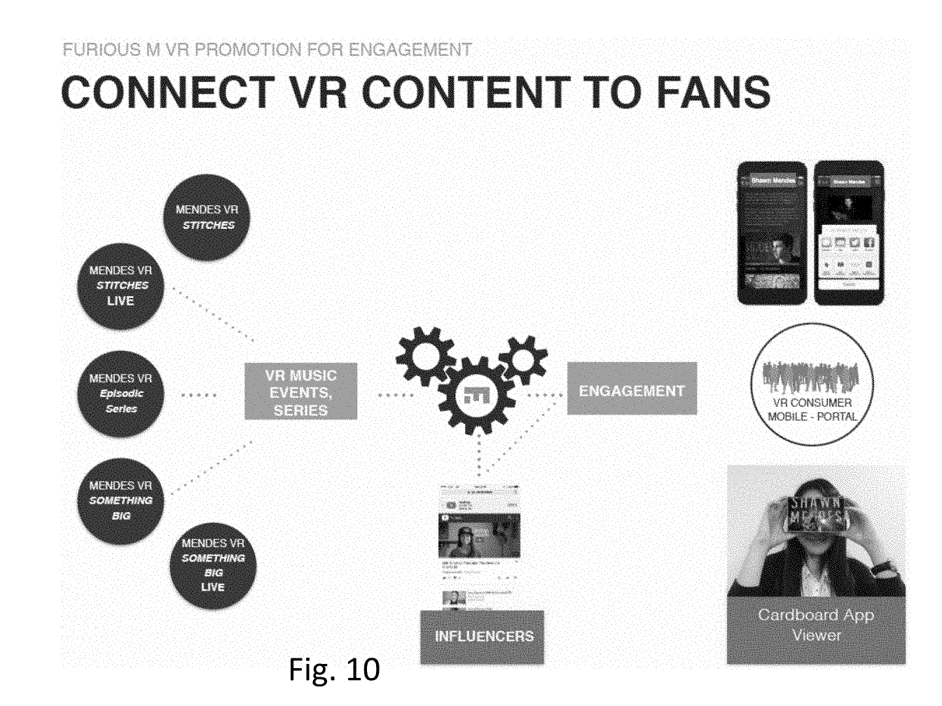

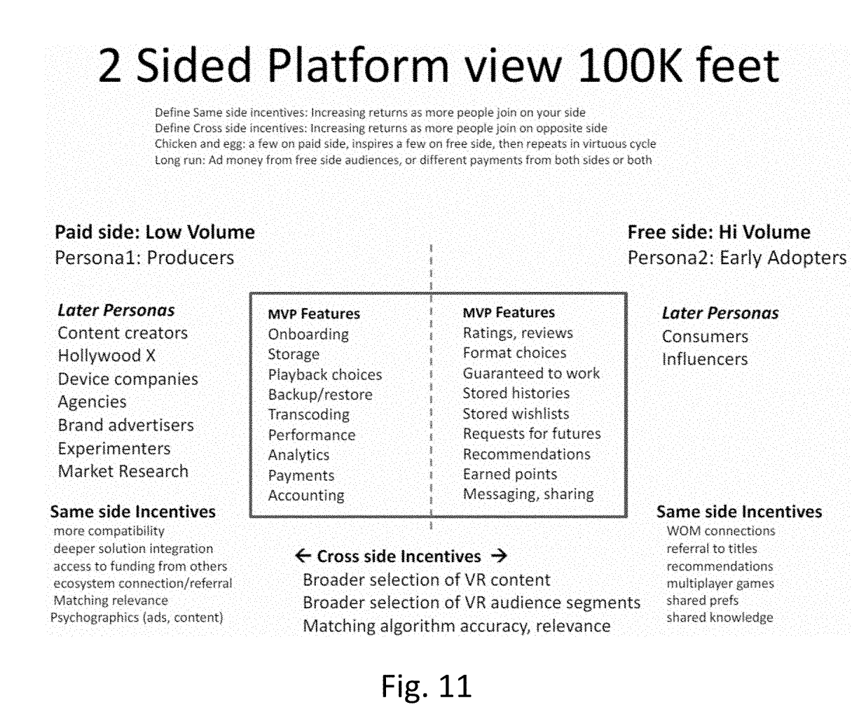

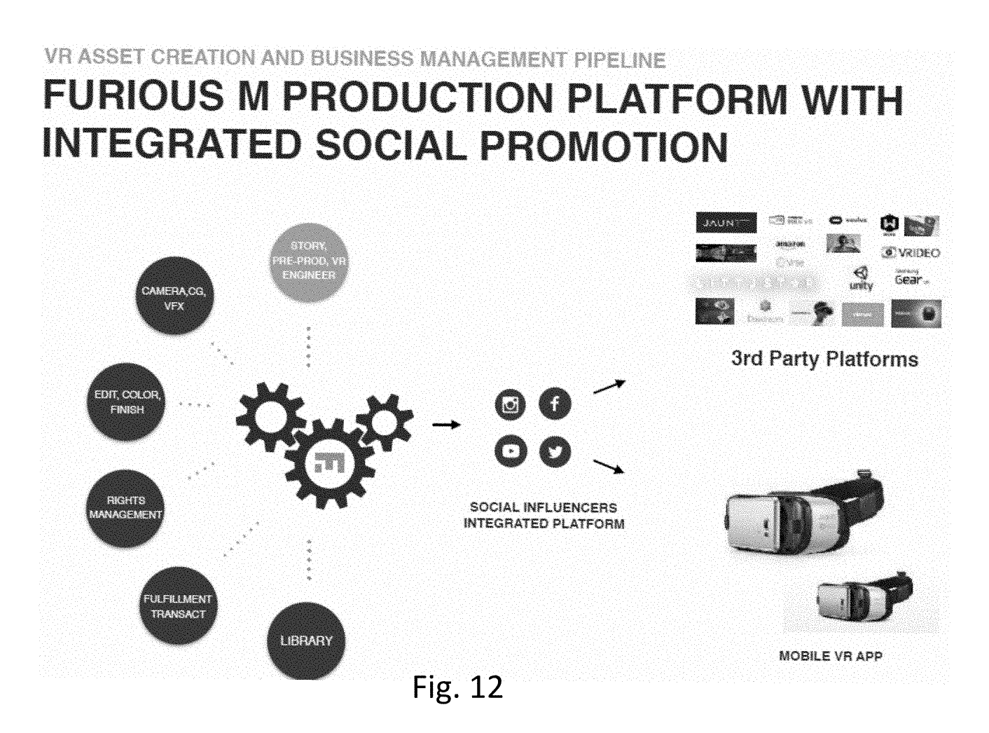

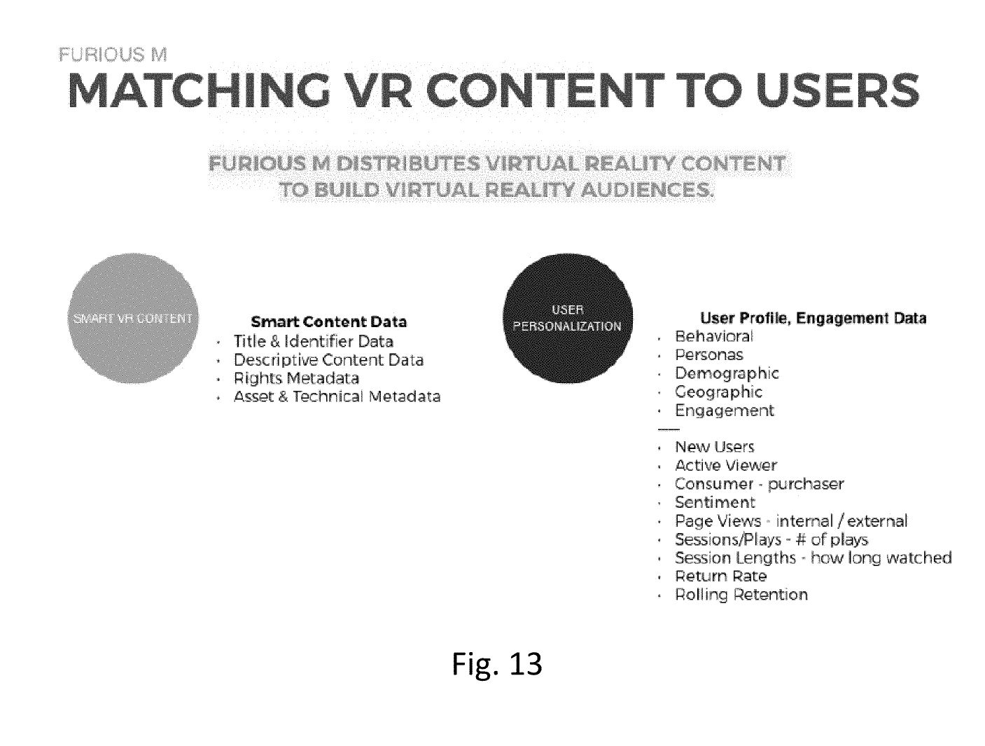

Referring to the drawings in detail, wherein like reference numerals indicate like elements throughout, FIGS. 1-16 illustrate systems and methods for producing media content for content delivery and finding interested audiences in the 21^{st} century by helping to identify an ideal user, customer and/or an ideal fan. The present disclosure is configured to use branded entertainment to connect digital viewers to virtual reality (“VR”). The present disclosure is configured to match personalized VR content to users and create VR consumers, and/or create or provide personalized programming to increase or gain audience engagement. The systems and methods of the present disclosure target, analyze, learn, personalize content, and connect.

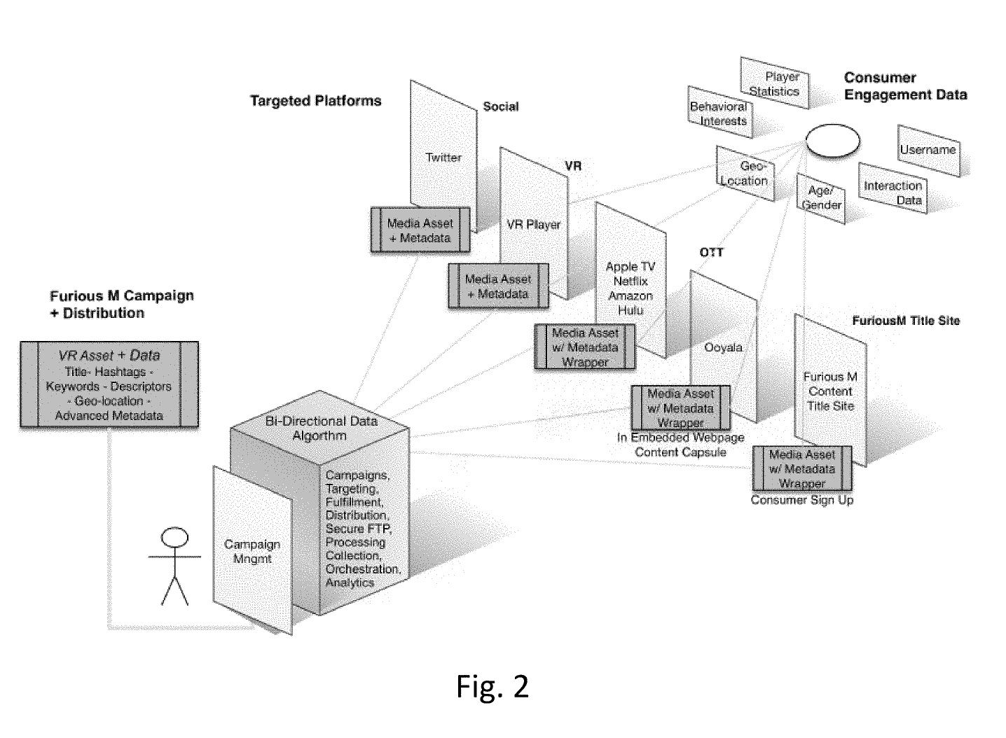

FIG. 1 is a schematic diagram of an embodiment of the present disclosure and FIG. 2 illustrates a magnified portion of the schematic diagram shown in FIG. 1. In one embodiment, the present disclosure enables use of specific metadata labeled entertainment media assets or smarter content. The labels or “tags” can contain actionable metadata to drive repeatable multi-channel interaction to reach users and engage them to view entertainment media content, facilitate interaction and find an audience to create fans and consumers. Actionable metadata tags are tags having a directive associated with them. For example, a user in a virtual reality space may be presented with a three dimensional pizza box from a pizza chain. The pizza box can have actionable metadata tags associated with it that track user engagement with the pizza box, such as whether the user's gaze fixates on the box and for how long. This tracked information can then be utilized by the system to update content tags and/or user profile information. In one embodiment, the system can be developed using software programs that are assembled into mechanisms that interoperate with internal and external databases and user systems on the internet and mobile networks.

The platform of the present disclosure can allow content owners to list productions, titles and/or subsidiary multi-format entertainment media. The platform of the present disclosure can allow entertainment producers to define multi-format entertainment media campaigns to target user bases. As used herein, entertainment producers or content producers refers to the producers of content delivery campaigns (sometimes referred to as showrunners) and not necessarily producers of individual content items. The platform of the present disclosure can be used to generate consumer interest in specific entertainment media products and/or generate exposure of the entertainment media. The platform of the present disclosure can be used to generate consumer interest in specific entertainment media products and/or generate advertising, which is tangentially and contextually associated with the viewing of the entertainment media products. The platform of the present disclosure can be used to facilitate interaction with targeted users and capture interaction data, organize collected data, analyze collected data, develop longitudinal analysis, and/or interpret and aggregate individual user data into categories for use in reporting on the data and/or for use in commercial resale of reports on the data. The platform of the present disclosure can be used to generate consumer interest in specific physical merchandise and direct individual users via invitations and offers to conduct commercial transactions for specific physical merchandise.

Entertainment media producers can assemble assets that have been specifically prepared and labeled into queuing systems that orchestrate optimized consumption across multiple platforms and multiple playout devices. Individual user profile information can be captured and aggregated to generate a database of user metrics that are mined (searched) to identify specific individuals who likely possess the propensity to like or have specified desire to consume a certain type of entertainment. Consumer users can access the entertainment playout on multiple or specific platforms via third party systems over the internet, extranets, social media, the web, mobile networks and/or the like.

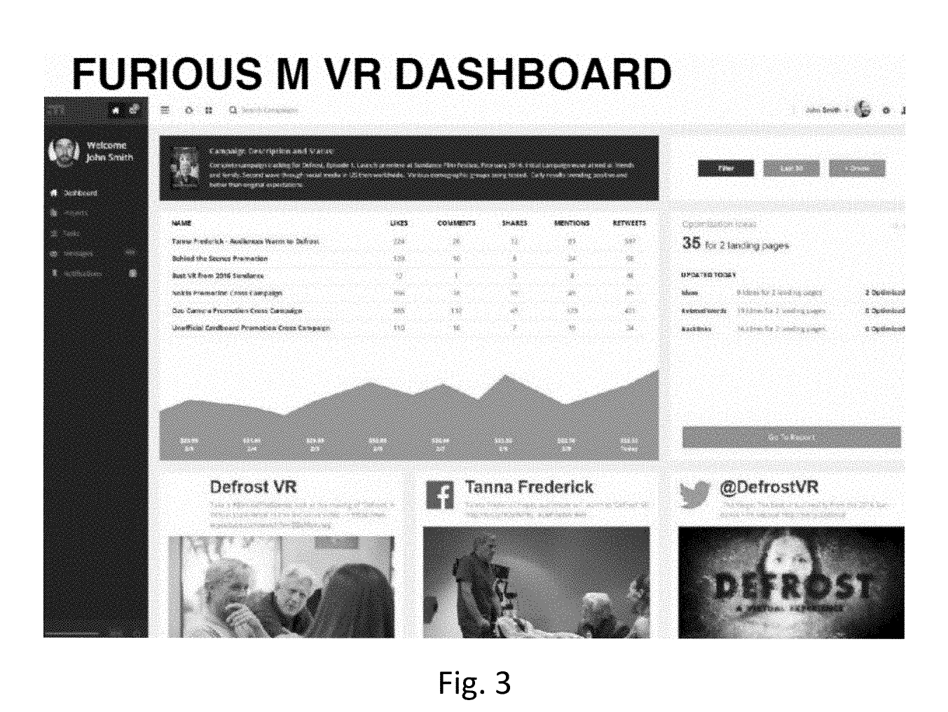

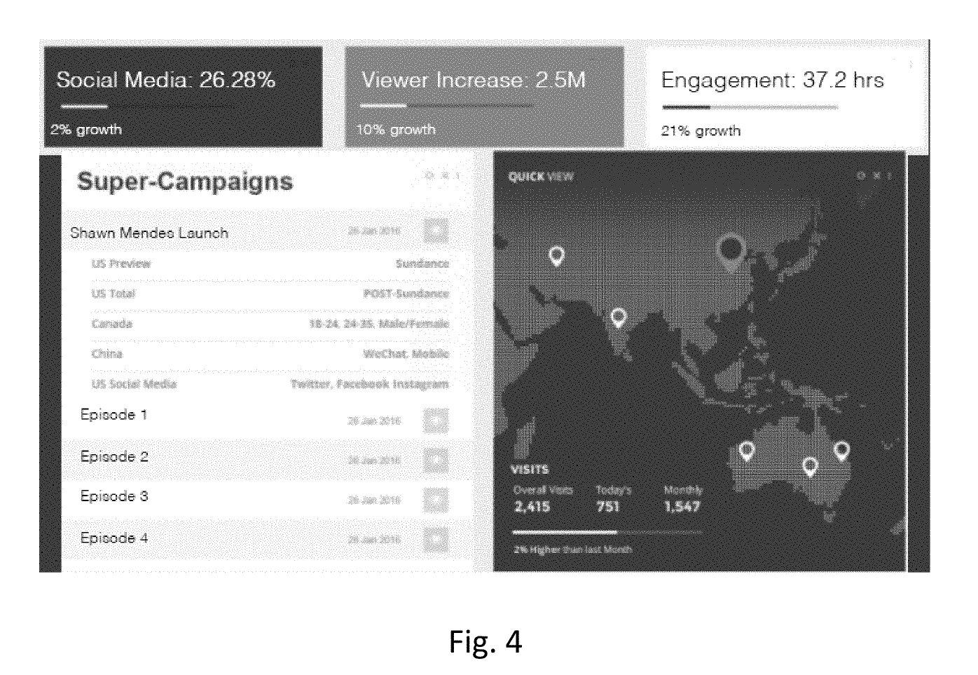

In operation, in one embodiment, a software mechanism platform can be employed to facilitate and orchestrate operations that pairs specific entertainment media content title data to a specific user identity. FIGS. 3 and 4 show examples of dashboards or graphical user interfaces in an embodiment of the present disclosure. The platform can operate to target users via a mechanism that incorporates entertainment content assets manufactured with metadata that represent content descriptions and are curated and prepared to be available for individualized consumption. The platform can automatically pick content based upon criteria selected by the entertainment producer. Metadata or descriptors can be used to match specifically-classified content with identified user categories that have a propensity to consume specific corresponding entertainment content.

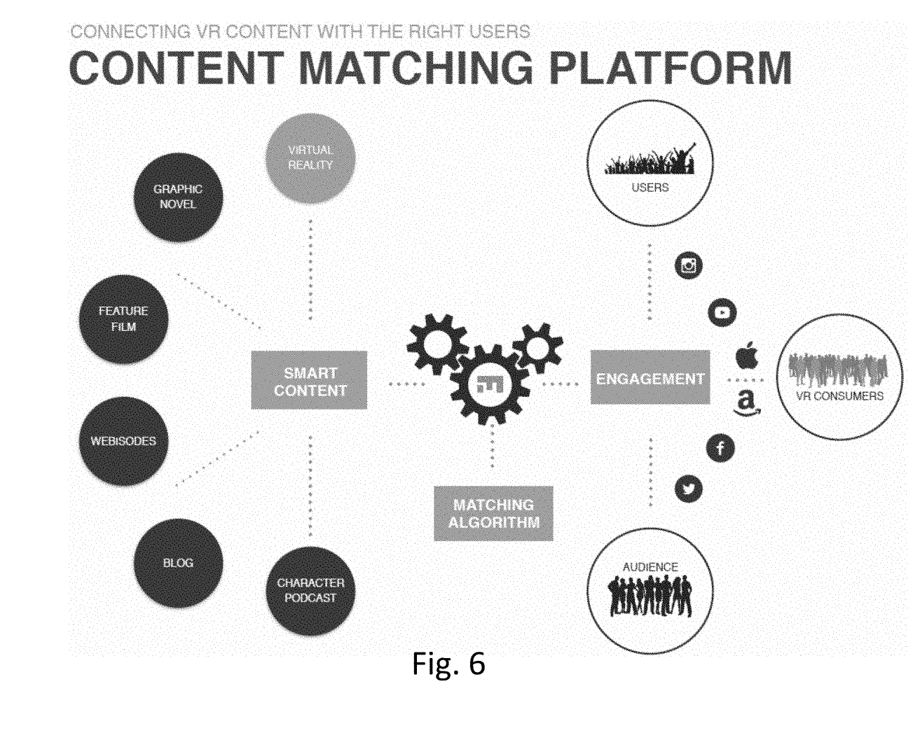

FIG. 6 is a schematic diagram of a dynamic content matching platform in an embodiment of the present disclosure. The platform can operate to initiate, sustain and/or scale processes that drive the mechanisms to perform determination of the propensity of an aggregated user base to engage in one specific type of entertainment media vs. another specific type of entertainment media. The platform can operate to initiate the selection of individual user identities for the purpose of matching a specific user identity with a specific entertainment media content title and publishes an offer to specific individual user to engage in an offer to consume the selected entertainment media content. The platform can operate again to initiate, sustain and/or scale processes that drive the mechanisms to perform determination of the propensity of the specific individual to engage in one specific type of entertainment media vs. another specific type of entertainment.

In one embodiment, the present disclosure provides content producers with actionable metadata tags to embed in content, which trigger a matching of their content to users whose interests match tags embedded in their content. In one embodiment, the present disclosure enables content producers to define a multi-platform, subsidiary multi-format campaign targeted to specific users. A key feature here is the use of subsidiary multi-format data as a “hook” or form of advertising to generate interest in a primary item of content. In one embodiment, the present disclosure provides content recommendations and subsidiary multi-format content to users based on their consumption histories, indicated preferences and behavioral data.

According to one embodiment, there can be two types of users of the system: business and viewers (consumers). Business users can register for the service via an application screen. The application can be evaluated by a production staff and, if approved, business users can be sent a confirmation notification and request for login credentials. Business users can then establish an account via the Administration User Interface. Business users can log out/login via their personalized Administration user interface pages and begin uploading/creating into their campaign and/or Distribution administration pages. An Administration page can include the following steps: 1) sign up, 2) accept terms, 3) provide assets, 4) execute campaign, 5) collect and aggregate data, 6) analyze data, 7) generate analytics, and 8) populate and publish key performance indicators (“KPI”) dashboard.

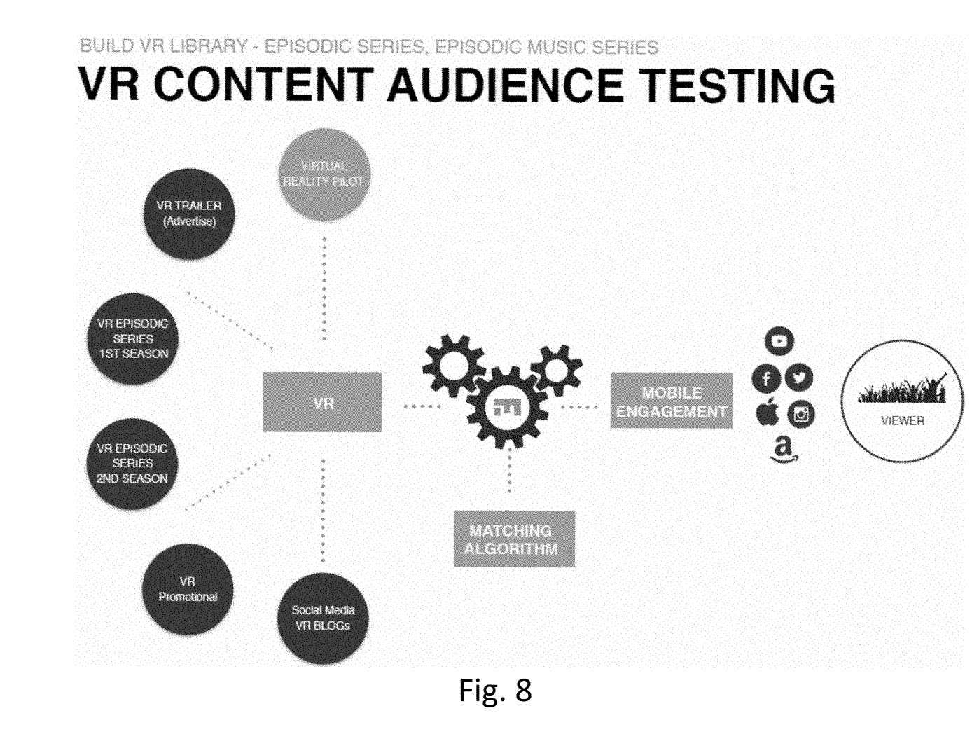

FIG. 8 illustrates a schematic diagram of a matching algorithm for mobile engagement to build viewership of VR content in an embodiment of the present disclosure. Viewer users can be presented with offers through various forms of solicited and unsolicited WEB, Mobile and OTT communications, notifications and/or publications, to view content as part of a promotional campaign. The communications can be delivered through various mediums, such as blogs and social media, including Facebook, Snapchat, Instagram, Twitter, Vine, tencent/WeChat, and via email, SMS messaging, printed publications, broadcast commercials and phone. Viewer users can be requested to view content, the views can be tracked, captured and aggregated as data and the data is categorically stored. Viewers can also be presented with an opportunity to acknowledge their interest in receiving additional content.

Campaigns may differ as to how viewer users are encouraged to view recommended content: some campaigns utilize all forms of notification communication listed above. Other campaigns include some or all of the above listed forms of communication and also include incentive offers, including free merchandise in return for personal data or free limited subscriptions to high value content. Repeat viewer users can be tracked and encouraged to become fans, fans in-turn can be converted to consumers. Viewers, fans and consumers in the aggregate can be considered to be the audience. Once viewers have provided key personal data in return for subscriptions or merchandise, they can be considered to have become fans. Fans can be encouraged to become consumers and can then be presented with two viewing options: paid subscriptions and/or free subscriptions that include advertising inserted into the content. The audience can be presented with content recommendations throughout their entire consumer lifecycle. See FIGS. 8-10.

Metrics can be accumulated through various forms of capture and paid submissions from partner and other third party systems (e.g., Google analytics, Reach Engine by Level Beyond video viewing data, such as length of video viewed). In addition, metrics can be captured through interaction with viewers, fans and consumers, including viewing positive or negative acknowledgements, submission of requests for additional content through sign-up or subscriber form submission. The metrics can be stored in a database of record for aggregation. User metrics can be gathered via content recommendations provided by the platform and users can also be encouraged to voluntarily provide content preferences through an online questionnaire.

In one embodiment, the system is a platform the can filter information and seek to predict ratings and preferences of a user of an item or social element. The system can utilize preexisting models and data that describe user characteristics in social environments and can then aggregate data to cull meaningful insight.

In one embodiment, the systems and methods of the present disclosure are capable of and configured to capture user sentiment at a more granular level than conventional electronic delivery content services. The systems and methods of the present disclosure can then curate audience data in more meaningful ways to extract and match viewer/fan/consumer interests with specific types of scenes, storylines and contextual data. This data can be aggregated with voluntarily provided detail from a viewer/fan/consumer interested in a particular title.

Major labels of the labeled entertainment media content mentioned above can be co-assigned by the content producers and consultants (agents) of the system, and can then be imported into the platform. In one sense, and in one embodiment, the labels can be essentially dynamic taxonomies, which expand and contract over time. Labels can be as simple as genre for a feature film or episodic series or playout technology such as virtual reality. User preferences can be curated based upon their affinity to other users. An affinity can first be established as a ranked order using such identifiers as enjoyment, empathy, immersion, social connection and personal identification to a concept or cause (e.g., a baseball fan).

In one embodiment, content producers provide background materials and promotion and advertising assets that are used to spark interest from a user. Examples of such materials are script/screenplay, director's notes, and storyboards. These materials can be used in various ways, for instance: if a user responds to particular video short (by watching the entire clip vs. only 2 seconds of the clip) about the making of the film, the response can be captured and ranked. Assets can be assembled in conventional filmmaking/file formatting ways. Editorial software for audio and video can be utilized to assemble and format assets or files for distribution then electronic delivery. The files can be collections of audio and video files generated from standard industry software products including Adobe Premiere Pro and other commercially available products. As used herein, “assets” are interchangeable with “content items.”

In one embodiment, content producers can manage and orchestrate the release management process from end to end (process and lifecycle) using the system Administration page. Content can be uploaded and release dates can be set. Step 1 can be a campaign to generate interest in the content. Step 2 can be setting a date when the release is set to deliver. Step 3 can be monitoring user interest. Step 4 can be approving release. Step 5 can be reviewing title consumption data by user. The labels can be encoded into the content (e.g., feature film, episodic, promotional material, etc.) prior to submission (publishing, streaming) or “loading.”

In one example, a new story can be created and produced specifically for playout in VR. The system can use all of the pertinent background assets to help drive interest in a title. The assets that can be used to drive interest over social media are not in VR (for example, a blog or 2D content items)—however a user can open a link to subscribe to the VR pilot episode in return for signing up and subscribing. The VR asset is prepared to playout on Samsung Gear or Oculus Rift and on cardboard (see Google cardboard) and viewed on their mobile phone.

The term “content title data” as used herein is synonymous with high-level metadata. An example from Star Wars via IMdb is as follows: Star Wars: The Force Awakens (2015) PG-13|135 min|Action, Adventure, Fantasy|18 Dec. 2015 (USA) 8.5 Your rating: −/10 Ratings: 8.5/10 from 350,061 users Metascore: 81/100 Reviews: 2,947 user|595 critic|52 from Metacritic.com Three decades after the defeat of the Galactic Empire, a new threat arises. The First Order attempts to rule the galaxy and only a ragtag group of heroes can stop them, along with the help of the Resistance. Director: J. J. Abrams Writers: Lawrence Kasdan, J. J. Abrams, 2 more credits>>Stars: Daisy Ridley, John Boyega, Oscar Isaac|See full cast and crew.

In one embodiment, screenplay data can be embedded at the frame level of the movies. An example of an asset being manufactured with metadata is as follows: Act 1, Scene 1: “the orderly wheels Joan out from behind the door”; Orderly winces and moans from the odor ‘steaming’ from Joan's skin, Joan has recently been resuscitated after being cryogenically frozen for 30 years. This is distinct from the assignment of content tags by an author to a video they upload to YouTube for example, because the systems and methods of the present disclosure tag are present at the frame level and can have modifiers at scene changes. The context of the story arc/scene/screenplay can be tagged in the file and as the scene plays. The screenplay data can be in the form of actionable metadata tags. The metadata tags can track user interaction or engagement with the content item. For example, the content that was displayed in a particular frame when a user engaged in a specific action (such as turning their gaze away from an object in virtual reality (VR) or stopping playback of videos). In another example, the actionable metadata tags can be used to trigger peripheral equipment, such as a scent collar, which can release different scents depending upon the content in a frame.

Assets can be curated according to use. For example, feature films and episodic series can all have ancillary assets used for promotion to drive users to consume the master file of the feature or episode. The storylines/genres (also referred to as content paths) can be the key guidelines to curating high-value content. Feature films and episodic series and their associated assets can then be curated based upon audience reaction to the content. There can be mechanisms that indicate a like or dislike. The systems and methods of the present disclosure can capture whether or not the entire clip or video was viewed, or stopped short, re-watched. User feedback can be used to curate titles.

In one embodiment, user can be exposed to promotional material about an episodic series through social media if they respond positively to a promotion by viewing a clip sent to them via social media. An offer can pop up (notification) at the end of the clip asking them if they would like to subscribe to watch the pilot episode for free. When a user responds positively to the request, the response can be captured and information about the user (18-24 male, lives in Wisconsin, student, etc.) is available can be attached to the episodic series title. This data can be aggregated by title—separate from the user database. The phrase “type of entertainment media” as used herein can include categories of media (in terms of genre or other content characteristics, 3D moves and VR.)

In some cases, the possible set of labels or tags can be defined by the platform. Certain delivery environments prevent some metadata from “coming across” to users—for instance, VR playout on an iOS device is constrained and will not function correctly on a Samsung Gear VR HMD, and, in one embodiment, the systems and methods of the present disclosure will not receive the same feedback about the users' engagement within the episode. In one embodiment, the tags can be standardized as much as possible. In some cases, all of the tags (metadata) are not available and will not be present. The system can have a template for metadata that is 1) required, 2) preferred, and 3) nice to have.

In operation, before a show is released by the system, a promotional campaign can be launched. The promotional campaign can be a multi-level digital or electronic media campaign that facilitates discovery of an unknown title. The system can utilize different mechanisms to drive out and orchestrate promotion, including embedding a micro-site link into a commercial or private blog, which links the user back to the show's main website to watch a trailer for the pilot episode. The micro-site link can actually be a mini-website and may contain, for example, a graphic novel, four (4) or one or more video clips, and/or an article about a real-world example related to the fictional character depicted in the show. If a new movie is promoted using a comic book, which takes place in the same “world” as the movie, this can qualify as subsidiary multi-format entertainment media. An entertainment producer can define these campaigns through interaction with the system's intake document, which create a campaign brief. The brief can essentially be a branding guide that directs how the show is promoted: who/what/where/how is it promoted. The brief can be an application that drives the various dates and/or actions (e.g., target audience demographic).

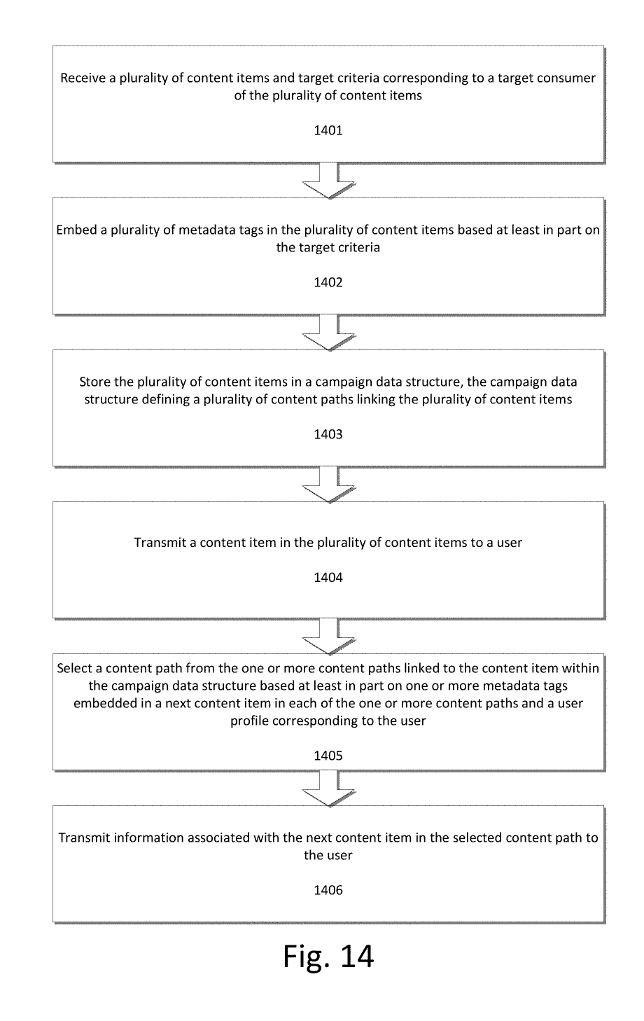

FIG. 14 illustrates a flowchart for content delivery according to an exemplary embodiment. The steps in the flowchart can be implemented using any of the systems, methods, or objects described in this specification.

At step 1401 a plurality of content items and target criteria corresponding to a target consumer of the plurality of content items are received. These can be received from a content owner or a service provider. For example, a service provider can contract with a content owner, such as a musical artist, to promote content items relating to the musical artist or brands associated or endorsed by the musical artist. The target criteria can identify the users that the service provider and/or the content owner wish to reach. The target criteria can be received in a standardized or structured format which can be parsed by the system to extract the relevant characteristics or attributes of the target user/target audience. The plurality of content items can include a plurality of different content formats such as one or more of virtual reality content, social media content, video content, image content, and/or textual content.

At step 1402 a plurality of metadata tags are embedded in the plurality of content items based at least in part on the target criteria. The metadata tags can be actionable tags, as discussed in this specification. The metadata tags can be based on the target criteria to identify relevant content items for different users within the spectrum of the target criteria. The metadata tags can also correspond to values or characteristics (such as personality traits or types) which are correlated or otherwise associated with one or more of the target criteria. The metadata tags can be assigned algorithmically, such as by parsing and mapping target criteria to certain attributes and identifying corresponding content items for those attributes.

At step 1403 the plurality of content items are stored in a campaign data structure. The campaign data structure defines a plurality of content paths linking the plurality of content items. Each content path in the plurality of content paths comprises a sequence of two or more content items in the plurality of content items. Additionally, each content item is linked within the campaign data structure to one or more content paths in the plurality of content paths. The campaign data structure can take any form, for example, a directed graph in which the content items are nodes and the paths are formed by links between the nodes. The content path corresponds to a sequence of content items that a user can navigate through, depending on the users profile and the metadata associated with the content items. The campaign data structure can be generated and stored automatically by software which performs an “orchestrator” function, by defining and storing in a data structure certain content delivery experiences formed of multiple items of content presented in sequence based upon one or more of the target criteria provided, the metadata tags assigned to content, and/or characteristics, personality traits, or other attributes of users. The campaign data structure can also be created and encoded by subject matter or content specialists. The sequence of two or more content items in each content path can correspond to two or more content formats. For example, a first content item can be a social media posting, whereas a second content item can be a virtual reality presentation or episode.

At step 1404 a content item in the plurality of content items is transmitted to a user. This transmission can include an initial transmission to a user either at a starting point of a content path or as a precursor to entering a content path. For example, this transmission can be an initial transmission based purely on demographic data and the target criteria to identify which users are responsive to the content campaign. The transmission can also be a content item that is sent while the user is on a content path within the content campaign.

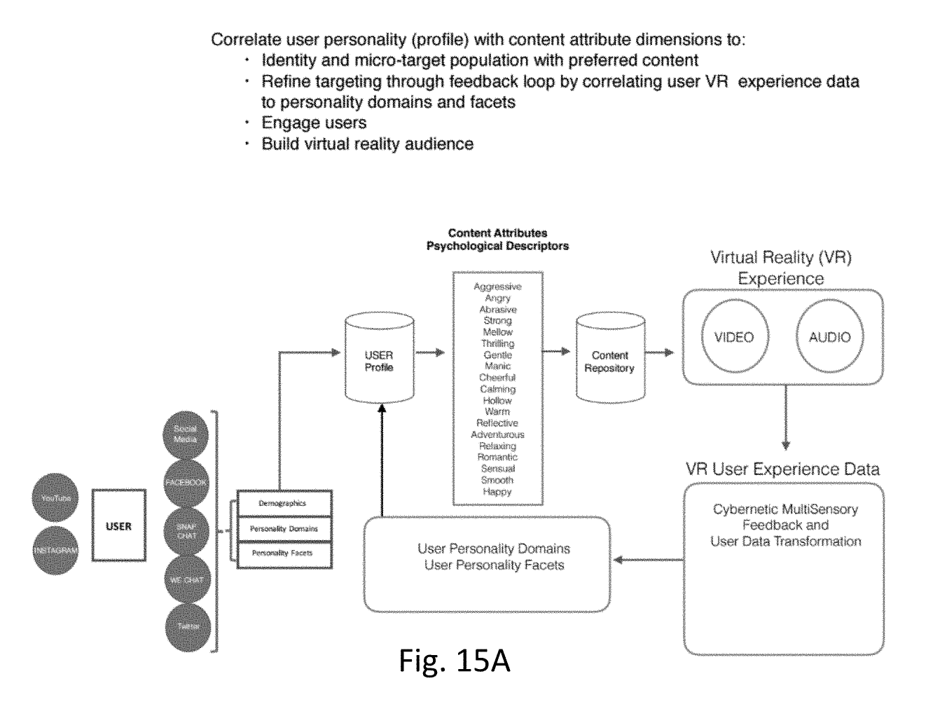

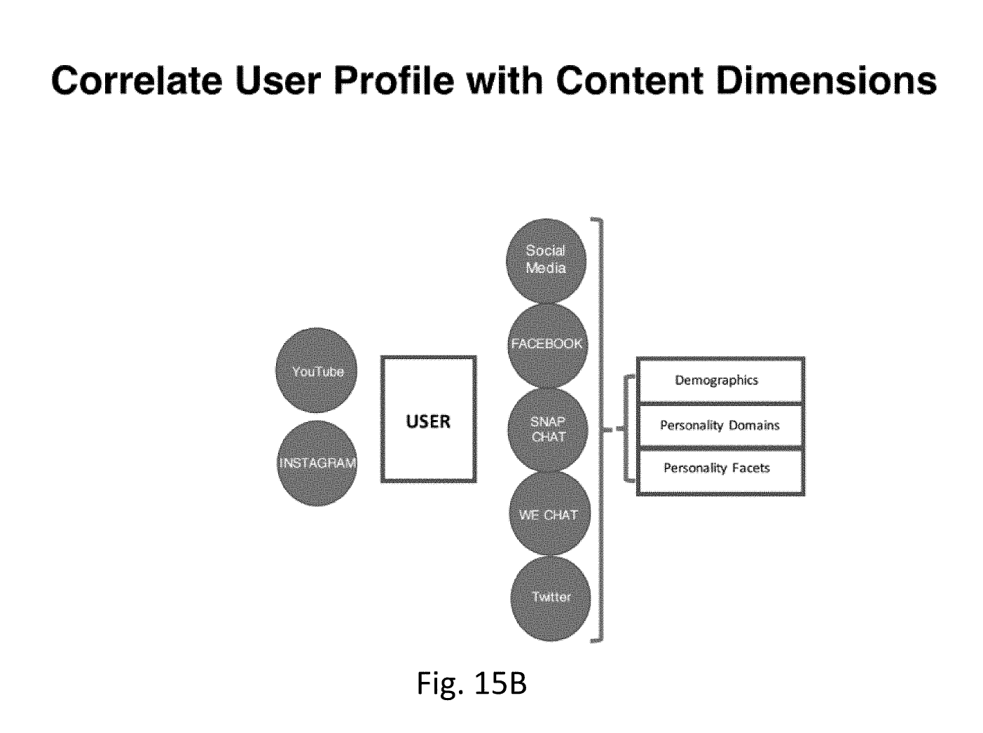

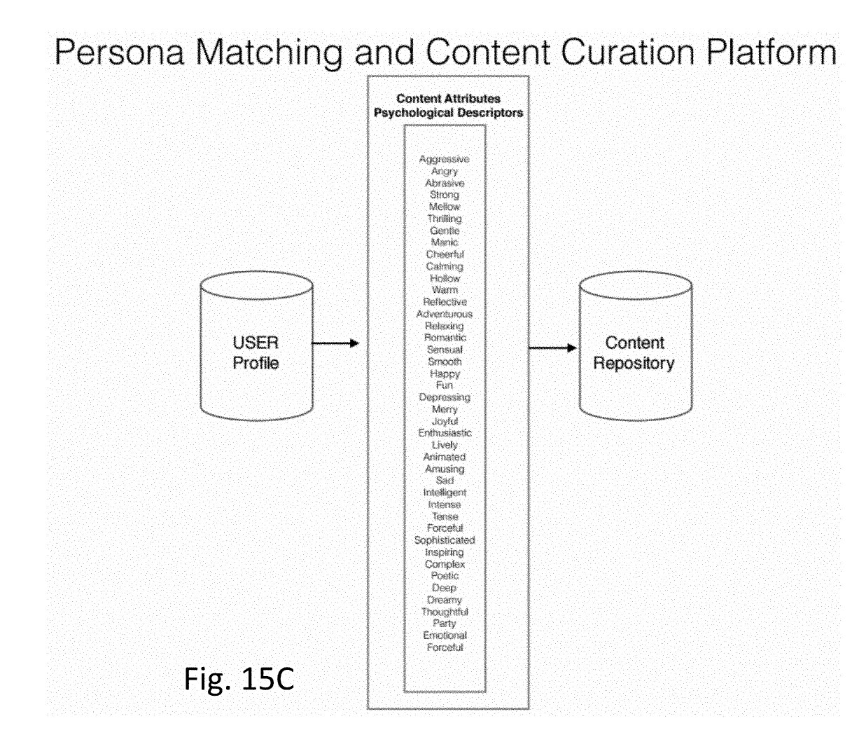

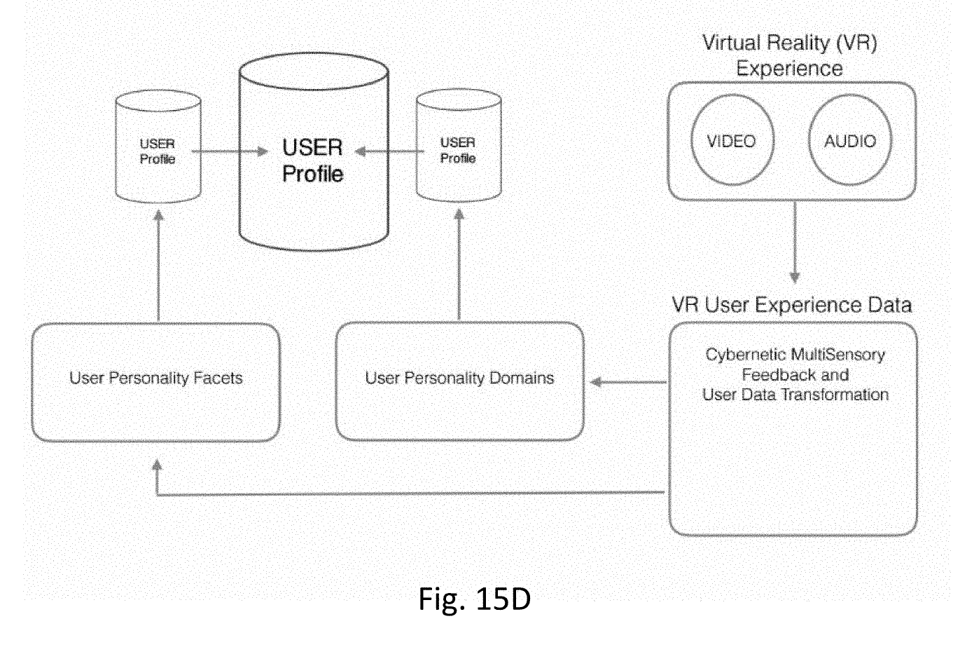

At step 1405 a content path is selected from the one or more content paths linked to the content item within the campaign data structure based at least in part on one or more metadata tags embedded in a next content item in each of the one or more content paths and a user profile corresponding to the user. This step can include filtering out at least one content path in the one or more content paths based at least in part on one or more demographic metadata tags embedded in a next content item in each of the one or more content paths and demographic information corresponding to the user. For example, if 2 out of 5 possible content paths (or next content items within the content paths) are associated with elderly users and the demographic data gathered on the user (either through the user interaction or collected elsewhere) indicates that the user is in the age range 20-25, then those content paths can be filtered out of the selection process. Selecting a content path can include comparing a characteristic in the user profile of the user with a corresponding metadata tag embedded in the next content item of each of the one or more content paths linked to the content item, and selecting a content path based at least in part on a determination that a corresponding metadata tag embedded in the next content item of a content path in the one or more content paths matches the characteristic in the user profile. FIGS. 15A-15D illustrate an example of this process in the context of content paths in a virtual reality environment.

At step 1406 information associated with the next content item in the selected content path to the user is transmitted to the user. This information can include the next content item in the selected content path itself, or it can include an offer to transmit the next content item. The next content item can be transmitted at the same time as a current content item. For example, in a VR environment, the next content item can be presented within a window or within the environment itself.

The process shown in FIG. 14 can also include receiving information corresponding to one or more user interactions associated with a metadata tag embedded in the content item and updating the user profile of the user corresponding to the user based at least in part on the received information. For example, the metadata tag embedded in the content item can be a frame metadata tag embedded in a frame of a video, the frame metadata tag including a content descriptor and a playback position. The received information can be information indicating that a user closed the video when a current playback position was equal to the playback position in the frame metadata tag. The user profile can updated based at least in part on the content descriptor in the frame metadata tag and some information indicating that the user closed the video.

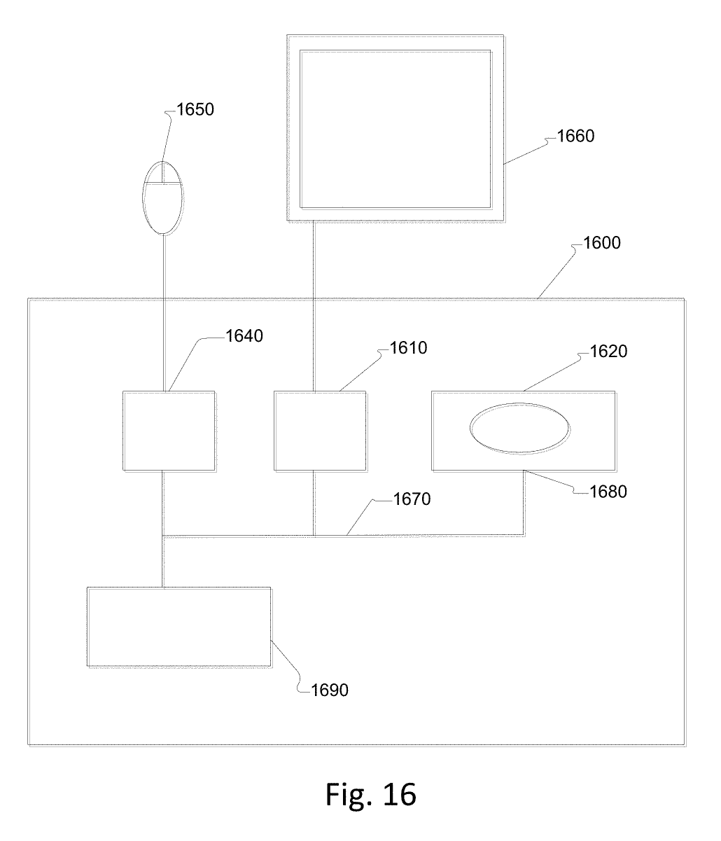

FIG. 16 illustrates an example of a computing environment 1600 that can be used to implement the methods and systems described herein. The computing environment 1600 is not intended to suggest any limitation as to scope of use or functionality of a described embodiment.

With reference to FIG. 16, the computing environment 1600 includes at least one processing unit 1610 and memory 1620. The processing unit 1610 executes computer-executable instructions and can be a real or a virtual processor. In a multi-processing system, multiple processing units execute computer-executable instructions to increase processing power. The memory 1620 can be volatile memory (e.g., registers, cache, RAM), non-volatile memory (e.g., ROM, EEPROM, flash memory, etc.), or some combination of the two. The memory 1620 can store software instructions 1680 for implementing the described techniques when executed by one or more processors. Memory 1620 can be one memory device or multiple memory devices.

A computing environment can have additional features. For example, the computing environment 1600 includes storage 1640, one or more input devices 1650, one or more output devices 1660, and one or more communication connections 1690. An interconnection mechanism 1670, such as a bus, controller, or network interconnects the components of the computing environment 1600. Typically, operating system software or firmware (not shown) provides an operating environment for other software executing in the computing environment 1600, and coordinates activities of the components of the computing environment 1600.

The storage 1640 can be removable or non-removable, and includes magnetic disks, magnetic tapes or cassettes, CD-ROMs, CD-RWs, DVDs, or any other medium which can be used to store information and which can be accessed within the computing environment 1600. The storage 1640 can store instructions for the software 1680.

The input device(s) 1650 can be a touch input device such as a virtual reality head mounted display, keyboard, mouse, pen, trackball, touch screen, or game controller, a voice input device, a scanning device, a digital camera, remote control, or another device that provides input to the computing environment 1600. The output device(s) 1660 can be a display, television, monitor, printer, speaker, virtual reality head mounted display or another device that provides output from the computing environment 1600.

The communication connection(s) 1690 enable communication over a communication medium to another computing entity. The communication medium conveys information such as computer-executable instructions, audio or video information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Implementations can be described in the general context of computer-readable media. Computer-readable media are any available media that can be accessed within a computing environment. By way of example, and not limitation, within the computing environment 1600, computer-readable media include memory 1620, storage 1640, communication media, and combinations of any of the above.

Of course, FIG. 16 illustrates computing environment 1600, display device 1660, and input device 1650 as separate devices for ease of identification only. Computing environment 1600, display device 1660, and input device 1650 can be separate devices (e.g., a personal computer connected by wires to a monitor and mouse), can be integrated in a single device (e.g., a mobile device with a touch-display, such as a virtual reality head mounted display, smartphone or a tablet), or any combination of devices (e.g., a computing device operatively coupled to a touch-screen display device, a plurality of computing devices attached to a single display device and input device, etc.). Computing environment 1600 can be a set-top box, mobile device, personal computer, or one or more servers, for example a farm of networked servers, a clustered server environment, or a cloud network of computing devices. Additionally, the systems and methods disclosed herein can be implemented as a web application which is accessed through a browser and over a communication connection.

Having described and illustrated the principles of our invention with reference to the described embodiment, it will be recognized that the described embodiment can be modified in arrangement and detail without departing from such principles. It should be understood that the programs, processes, or methods described herein are not related or limited to any particular type of computing environment, unless indicated otherwise. Various types of general purpose or specialized computing environments can be used with or perform operations in accordance with the teachings described herein. Elements of the described embodiment shown in software can be implemented in hardware, as discussed above, and vice versa.

In view of the many possible embodiments to which the principles of our invention can be applied, we claim as our invention all such embodiments as can come within the scope and spirit of the following claims and equivalents thereto

1. A method executed by one or more computing devices for content delivery, the method comprising:
receiving, by at least one of the one or more computing devices, a plurality of content items and target criteria corresponding to a target consumer of the plurality of content items;
embedding, by at least one of the one or more computing devices, a plurality of metadata tags in the plurality of content items based at least in part on the target criteria;
storing, by at least one of the one or more computing devices, the plurality of content items in a campaign data structure, wherein the campaign data structure defines a plurality of content paths linking the plurality of content items, wherein each content path in the plurality of content paths comprises a sequence of two or more content items in the plurality of content items, and wherein each content item is linked within the campaign data structure to one or more content paths in the plurality of content paths;
transmitting, by at least one of the one or more computing devices, a content item in the plurality of content items to a user;
selecting, by at least one of the one or more computing devices, a content path from the one or more content paths linked to the content item within the campaign data structure based at least in part on one or more metadata tags embedded in a next content item in each of the one or more content paths and a user profile corresponding to the user;
transmitting, by at least one of the one or more computing devices, information associated with the next content item in the selected content path to the user.

2. The method of claim 1, wherein selecting a content path from the one or more content paths linked to that content item within the campaign data structure based at least in part on one or more metadata tags embedded in a next content item in each of the one or more content paths and a profile corresponding to the user comprises:
filtering out at least one content path in the one or more content paths based at least in part on one or more demographic metadata tags embedded in a next content item in each of the one or more content paths and demographic information corresponding to the user.

3. The method of claim 1, wherein selecting a content path from the one or more content paths linked to that content item within the campaign data structure based at least in part on one or more metadata tags embedded in a next content item in each of the one or more content paths and a profile corresponding to the user comprises:
comparing a characteristic in the user profile of the user with a corresponding metadata tag embedded in the next content item of each of the one or more content paths linked to the content item; and
selecting a content path based at least in part on a determination that a corresponding metadata tag embedded in the next content item of a content path in the one or more content paths matches the characteristic in the user profile.

4. The method of claim 1, further comprising:
receiving, by at least one of the one or more computing devices, information corresponding to one or more user interactions associated with a metadata tag embedded in the content item; and
updating, by at least one of the one or more computing devices, the user profile of the user corresponding to the user based at least in part on the received information.

5. The method of claim 3, wherein the metadata tag embedded in the content item comprises a frame metadata tag embedded in a frame of a video, the frame metadata tag comprising a content descriptor and a playback position, wherein the received information comprises information indicating that a user closed the video when a current playback position was equal to the playback position in the frame metadata tag, and wherein the user profile is updated based at least in part on the content descriptor in the frame metadata tag.

6. The method of claim 1, wherein the plurality of content items comprise a plurality of different content formats and wherein the sequence of two or more content items in each content path correspond to two or more content formats.

7. The method of claim 6, wherein the plurality of different content formats comprise one or more of: virtual reality content, social media content, video content, image content, or textual content.

8. An apparatus for content delivery, the apparatus comprising:
one or more processors; and
one or more memories operatively coupled to at least one of the one or more processors and having instructions stored thereon that, when executed by at least one of the one or more processors, cause at least one of the one or more processors to:
receive a plurality of content items and target criteria corresponding to a target consumer of the plurality of content items;
embed a plurality of metadata tags in the plurality of content items based at least in part on the target criteria;
store the plurality of content items in a campaign data structure, wherein the campaign data structure defines a plurality of content paths linking the plurality of content items, wherein each content path in the plurality of content paths comprises a sequence of two or more content items in the plurality of content items, and wherein each content item is linked within the campaign data structure to one or more content paths in the plurality of content paths;
transmit a content item in the plurality of content items to a user;
select a content path from the one or more content paths linked to the content item within the campaign data structure based at least in part on one or more metadata tags embedded in a next content item in each of the one or more content paths and a user profile corresponding to the user;
transmit information associated with the next content item in the selected content path to the user.

9. The apparatus of claim 8, wherein the instructions that, when executed by at least one of the one or more processors, cause at least one of the one or more processors to select a content path from the one or more content paths linked to that content item within the campaign data structure based at least in part on one or more metadata tags embedded in a next content item in each of the one or more content paths and a profile corresponding to the user further cause at least one of the one or more processors to:
filter out at least one content path in the one or more content paths based at least in part on one or more demographic metadata tags embedded in a next content item in each of the one or more content paths and demographic information corresponding to the user.

10. The apparatus of claim 8, wherein the instructions that, when executed by at least one of the one or more processors, cause at least one of the one or more processors to select a content path from the one or more content paths linked to that content item within the campaign data structure based at least in part on one or more metadata tags embedded in a next content item in each of the one or more content paths and a profile corresponding to the user further cause at least one of the one or more processors to:
compare a characteristic in the user profile of the user with a corresponding metadata tag embedded in the next content item of each of the one or more content paths linked to the content item; and
select a content path based at least in part on a determination that a corresponding metadata tag embedded in the next content item of a content path in the one or more content paths matches the characteristic in the user profile.

11. The apparatus of claim 8, wherein at least one of the one or more memories has further instructions stored thereon that, when executed by at least one of the one or more processors, cause at least one of the one or more processors to:
receive information corresponding to one or more user interactions associated with a metadata tag embedded in the content item; and
update the user profile of the user corresponding to the user based at least in part on the received information.

12. The apparatus of claim 11, wherein the metadata tag embedded in the content item comprises a frame metadata tag embedded in a frame of a video, the frame metadata tag comprising a content descriptor and a playback position, wherein the received information comprises information indicating that a user closed the video when a current playback position was equal to the playback position in the frame metadata tag, and wherein the user profile is updated based at least in part on the content descriptor in the frame metadata tag.

13. The apparatus of claim 8, wherein the plurality of content items comprise a plurality of different content formats and wherein the sequence of two or more content items in each content path correspond to two or more content formats.

14. The apparatus of claim 13, wherein the plurality of different content formats comprise one or more of: virtual reality content, social media content, video content, image content, or textual content.

15. At least one non-transitory computer-readable medium storing computer-readable instructions that, when executed by one or more computing devices, cause at least one of the one or more computing devices to:
receive a plurality of content items and target criteria corresponding to a target consumer of the plurality of content items;
embed a plurality of metadata tags in the plurality of content items based at least in part on the target criteria;
store the plurality of content items in a campaign data structure, wherein the campaign data structure defines a plurality of content paths linking the plurality of content items, wherein each content path in the plurality of content paths comprises a sequence of two or more content items in the plurality of content items, and wherein each content item is linked within the campaign data structure to one or more content paths in the plurality of content paths;
transmit a content item in the plurality of content items to a user;
select a content path from the one or more content paths linked to the content item within the campaign data structure based at least in part on one or more metadata tags embedded in a next content item in each of the one or more content paths and a user profile corresponding to the user;
transmit information associated with the next content item in the selected content path to the user.

16. The at least one non-transitory computer-readable medium of claim 15, wherein the instructions that, when executed by at least one of the one or more computing devices, cause at least one of the one or more computing devices to select a content path from the one or more content paths linked to that content item within the campaign data structure based at least in part on one or more metadata tags embedded in a next content item in each of the one or more content paths and a profile corresponding to the user further cause at least one of the one or more computing devices to:
filter out at least one content path in the one or more content paths based at least in part on one or more demographic metadata tags embedded in a next content item in each of the one or more content paths and demographic information corresponding to the user.

17. The at least one non-transitory computer-readable medium of claim 15, wherein the instructions that, when executed by at least one of the one or more computing devices, cause at least one of the one or more computing devices to select a content path from the one or more content paths linked to that content item within the campaign data structure based at least in part on one or more metadata tags embedded in a next content item in each of the one or more content paths and a profile corresponding to the user further cause at least one of the one or more computing devices to:
compare a characteristic in the user profile of the user with a corresponding metadata tag embedded in the next content item of each of the one or more content paths linked to the content item; and
select a content path based at least in part on a determination that a corresponding metadata tag embedded in the next content item of a content path in the one or more content paths matches the characteristic in the user profile.

18. The at least one non-transitory computer-readable medium of claim 15, further storing computer-readable instructions that, when executed by at least one of the one or more computing devices, cause at least one of the one or more computing devices to:
receive information corresponding to one or more user interactions associated with a metadata tag embedded in the content item; and
update the user profile of the user corresponding to the user based at least in part on the received information.

19. The at least one non-transitory computer-readable medium of claim 18, wherein the metadata tag embedded in the content item comprises a frame metadata tag embedded in a frame of a video, the frame metadata tag comprising a content descriptor and a playback position, wherein the received information comprises information indicating that a user closed the video when a current playback position was equal to the playback position in the frame metadata tag, and wherein the user profile is updated based at least in part on the content descriptor in the frame metadata tag.

20. The at least one non-transitory computer-readable medium of claim 15, wherein the plurality of content items comprise a plurality of different content formats and wherein the sequence of two or more content items in each content path correspond to two or more content formats.

21. The at least one non-transitory computer-readable medium of claim 20, wherein the plurality of different content formats comprise one or more of: virtual reality content, social media content, video content, image content, or textual content.
